(19) United States
(12) Patent Application Publication
(10) Pub. No.: US 2009/0310145 A1
(43) Pub. Date: Dec. 17, 2009

(54) POSITIONING APPARATUS, POSITIONING METHOD, EXPOSURE APPARATUS, DEVICE MANUFACTURING METHOD, AND METHODS OF MANUFACTURING POSITIONING APPARATUS AND EXPOSURE APPARATUS

(75) Inventors: Yusuke Sugiyama, Utsunomiya-shi (JP); Hirohito Ito, Utsunomiya-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/478,294

(22) Filed: Jun. 4, 2009

(30) Foreign Application Priority Data
Jun. 11, 2008 (JP) 2008-153397
Apr. 17, 2009 (JP) 2009-101375

(51) Int. Cl. G01B 11/14

(52) U.S. Cl. 356/614

(57) ABSTRACT

A positioning apparatus comprises a controller for controlling a driving device, and positions a measurement portion of an optical element. The controller displaces a drive portion of the optical element by a specific operation of the driving device, and calculate a displacement of the optical element as a first displacement based on an output from a position measuring device, calculate a displacement of the optical element caused by the specific operation as a second displacement, based on an output from a wavefront measuring device configured to measure a wavefront of light directed by the optical element, based on a difference between the first displacement and the second displacement, calibrate a position of the optical element calculated from the output from the position measuring device, and store a result of the calibration, and control the driving device based on the stored calibration result and an output from the position measuring device.

### BACKGROUND OF THE INVENTION

1. Field of the Invention

The present invention relates to a positioning apparatus for positioning a drive portion of an optical element, a positioning method of positioning the same, an exposure apparatus, a device manufacturing method, and methods of manufacturing the positioning apparatus and exposure apparatus.

2. Description of the Related Art

An exposure apparatus represented by a semiconductor exposure apparatus that transfers patterns of a reticle onto a photosensitive substrate (to be also simply referred to as a substrate or wafer hereinafter) by exposing the substrate via the reticle patterns and a projection optical system is known. For example, a step-and-repeat type reduction projection exposure apparatus (a so-called stepper) and a step-and-scan type reduction projection exposure apparatus (a so-called scanning stepper) are mainly used.

When manufacturing, for example, a semiconductor element having a high integration degree, many different types of patterns must be layered on a substrate. This makes it necessary to accurately overlay and transfer reticle patterns onto patterns already formed on a substrate. To transfer patterns with high overlay precision, the optical characteristics of a projection optical system must be adjusted to a predetermined state. It is particularly necessary to suppress the residual wavefront aberration as the optical characteristic.

Also, to suppress the wavefront aberration, it is desirable to suppress the change in optical characteristic caused by the heat of exposure light. In an exposure step that is intermittently performed, an optical element is locally heated by absorption of the heat of exposure light and thermally deforms, and this may change the optical characteristic. To suppress the change in optical characteristic caused by the heat of exposure light, it is possible to, for example, cool the optical element or moderate the temperature distribution. As a method of positively correcting the change in optical characteristic, it is possible to, for example, estimate, from the exposure log, the characteristic change of an optical element caused by the heat of exposure light and move the optical element or change the surface shape of the optical element based on this estimation.

To appropriately adjust the optical characteristics, particularly, the wavefront aberration of a projection optical system, a method of moving an optical element (Japanese Patent Laid-Open No. 2002-131605) and a method of changing the surface shape of an optical element (Japanese Patent Laid-Open No. 4-372811) have been proposed. The former method has disclosed a six-degree-of-freedom optical element positioning mechanism using a driving mechanism and lens frame position measurement mechanism, and can correct, for example, image distortion and a magnification error. The latter method performs wavefront measurement on the surface of a mirror, and drives an actuator placed on the rear surface of the mirror, based on the measurement, thereby changing the surface shape so as to obtain desired optical characteristics.

When an optical element is moved by the driving mechanism as disclosed in Japanese Patent Laid-Open No. 2002-131605, the optical element deforms more or less, and a measurement portion or a portion to be measured to be subjected to position measurement can also deform. In addition, a mounting error of the position measurement mechanism can change the relative positional relationship between a position detecting mechanism and the measurement portion. The deformation, mounting error, and relative positional change as described above make accurate calibration of the position measurement mechanism necessary in order to achieve high-precision positioning.

Wavefront measurement as disclosed in Japanese Patent Laid-Open No. 4-372811 has the advantage that the displacement and deformation of an optical element can be obtained by the analysis of the wavefront aberration. However, it is difficult to correct the displacement of an optical element caused by, for example, surface-deformation-drive or an assembling error by the actuator placed on the rear surface of the optical element, because the movable range is limited. Therefore, this method can be used together with the positioning mechanism as disclosed in Japanese Patent Laid-Open No. 2002-131605. In this case, calibration of the position measurement mechanism is necessary as described previously. In addition, since surface-deformation-drive produces displacement, it is also necessary to calibrate a surface-deformation-driving mechanism so that the operation of the surface-deformation-driving mechanism does not interfere with that of the positioning mechanism.

Furthermore, Japanese Patent Laid-Open No. 2002-324752 has disclosed a method as a conventional method of correcting the aberration of a projection optical system. This method adjusts the optical characteristics of a projection optical system based on the result of measurement of the wavefront aberration of the system. In this adjustment, an optical element forming the projection optical system is moved at a predetermined degree of freedom by controlling a driving element such as a piezo element. Also, to obtain the adjustment amount of the driving element based on the wavefront aberration measurement result, the adjustment amount is calibrated as it is associated with a wavefront aberration fluctuation amount.

In the calibration method disclosed in Japanese Patent Laid-Open No. 2002-324752, however, the position or surface shape of an optical element is not always strictly adjusted. That is, even when the adjustment amount of the driving element is accurate, it is impossible to guarantee that an optical element is accurately moved to a state in which the optical characteristics are satisfied. In addition, the optical characteristics after the driving element is adjusted can be grasped by only the adjustment amount, so desired optical characteristics are difficult to maintain. This requires frequent calibration, and increases the time and procedure for the calibration. Moreover, the method cannot cope with, for example, a change in structure with time occurring after the optical characteristics of a projection optical system are adjusted. This may make readjustment necessary. For these reasons, the position measurement mechanism is required to precisely position an optical element.

To correct the optical characteristic change caused by the heat of exposure light by using the adjusting method disclosed in Japanese Patent Laid-Open No. 2002-324752, it is necessary to premeasure the change in optical characteristic caused by the heat of exposure light by measuring the wavefront aberration of a projection optical system. However, although the heat of exposure light changes the optical characteristic during exposure, wavefront measurement cannot be performed during exposure. In a situation in which no wavefront measurement can be performed, it is impossible to assure satisfactory optical characteristics even if the adjustment amount of the driving element is accurate. Accordingly, an optical element position measurement mechanism is necessary to position an optical element by estimating the change in optical characteristic caused by the heat of exposure light.

### SUMMARY OF THE INVENTION

As described above, an optical element position measurement device is necessary to adjust the optical characteristics more precisely. To position an optical element more precisely, the position measurement device must be accurately calibrated.

The present invention has been made in consideration of the above background, and has its exemplary object to perform an accurate calibration of a position measurement device for measuring a position of a measurement portion of an optical element.

The present invention provide a positioning apparatus which comprises a position measuring device configured to measure a position of a measurement portion of an optical element, a driving device configured to displace a drive portion of the optical element, and a controller configured to control the driving device, and positions the measurement portion of the optical element, wherein the controller is configured to displace the drive portion of the optical element by a specific operation of the driving device, and calculate a displacement of the optical element as a first displacement based on an output from the position measuring device, calculate a displacement of the optical element caused by the specific operation as a second displacement, based on an output from a wavefront measuring device configured to measure a wavefront of light directed by the optical element, based on a difference between the first displacement and the second displacement, calibrate a position of the optical element calculated from the output from the position measuring device, and store a result of the calibration, and control the driving device based on the stored calibration result and an output from the position measuring device.

The present invention makes it possible to provide a position measurement device for accurately measuring the position of a measurement portion of an optical element.

Further features of the present invention will become apparent from the following description of exemplary embodiments with reference to the attached drawings.

### BRIEF DESCRIPTION OF THE DRAWINGS

FIG. 1 is a view showing an example of the arrangement of an optical element positioning apparatus according to the first embodiment of the present invention;

FIG. 2 is a conceptual view showing the state of optical element position measurement;

FIG. 3 is a conceptual view showing the state of optical element position measurement;

FIG. 4 is a flowchart showing an example of the procedure of calibration;

FIG. 5 is a flowchart showing the procedure of a process in step 103 of FIG. 4;

FIG. 6 is a flowchart showing the procedure of a process in step 105 of FIG. 4;

FIG. 7 is a flowchart showing the procedure of a process in step 131 of FIG. 6;

FIG. 8 is a flowchart showing the procedure of a process in step 142 of FIG. 7;

FIG. 9 is a flowchart showing the procedure of a process in step 143 of FIG. 7;

FIG. 10 is a flowchart showing another example of the procedure of calibration;

FIG. 11 is a flowchart showing still another example of the procedure of calibration;

FIG. 12 is a view showing another example of the arrangement of the optical element positioning apparatus;

FIG. 13 is a flowchart showing the procedure of positioning of an optical element;

FIG. 14 is a flowchart showing the process of obtaining the position of an optical element according to the second embodiment;

FIG. 15 is a view showing an example of the arrangement of an apparatus that positions and deforms an optical element according to the fourth embodiment;

FIG. 16 is a view showing an example of the arrangement of an exposure apparatus according to the fifth embodiment;

FIG. 17 is a flowchart showing the procedure of calibration;

FIG. 18 is a flowchart showing the procedure of positioning of an optical element;

FIG. 19 is a flowchart showing the procedure of formation of a projection table;

FIG. 20 is a flowchart showing the procedure of calibration of a position measurement device; and

FIG. 21 is a flowchart showing the procedure of a process in step 143 of FIG. 7 according to the fifth embodiment.

### DESCRIPTION OF THE EMBODIMENTS

A positioning apparatus, a positioning method, an exposure apparatus, methods of manufacturing the positioning apparatus and exposure apparatus, and a device manufacturing method according to the present invention will be explained below with reference to the accompanying drawings.

### First Embodiment

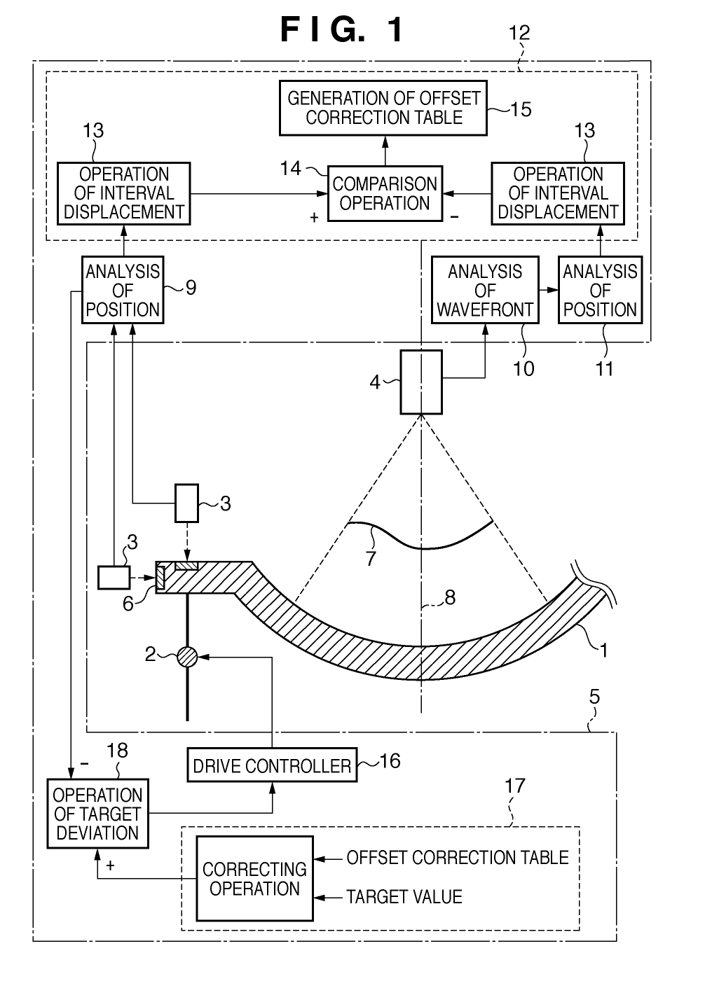

FIG. 1 is a view showing an example of the arrangement of an optical element positioning apparatus according to the first embodiment of the present invention. This positioning apparatus is incorporated into, for example, an exposure apparatus. An exemplary arrangement of the positioning apparatus includes an optical element 1 to be controlled, a driving device 2 for displacing a drive portion, a portion to be driven, or a portion to which a driving force is applied, of the optical element 1, a position measurement device 3 for measuring the position of a measurement portion of the optical element 1, a wavefront measurement device 4 for measuring the wavefront of light guided by the optical element 1, and a controller 5.

The optical element 1 is, for example, a concave mirror in a projection optical system of an exposure apparatus. The driving device 2 includes an actuator, and can perform positioning for at least one of a total of six degrees of freedom including three degrees of freedom parallel and translational to three axes (an optical axis 8 and two axes perpendicular to the optical axis 8 and perpendicular to each other), and three degrees of freedom of rotation around the three axes. Desirably, it is also possible to impart a function of suppressing the transmission of vibration by connecting the optical element 1 and driving device 2 by a connecting member such as an elastic hinge. The position measurement device 3 measures the position of a measurement portion 6 on the optical element surface or on a surface having a predetermined relative positional relationship with the optical element 1 and processed to have sufficient flatness, by, for example, measurement using a laser interferometer. Note that the measurement portion 6 exists outside the effective region of the optical element, so the position can be measured even while a substrate is exposed. The wavefront measurement device 4 includes a known wavefront measurement device such as a Fizeau interferometer, and can measure a wavefront 7 (actually the wavefront aberration obtained from a phase difference from a reference wavefront on a measurement optical path) of light reflected by the mirror (optical element 1). The controller 5 controls the driving device 2 and measurement devices 3 and 4, stores data for measurement and analysis, performs operations for analysis, and the like.

The controller 5 has a position analysis unit 9 that receives an output signal from the position measurement device 3 and calculates the position of the optical element 1. Assuming that the optical axis direction is the Z-axis of an orthogonal coordinate system, the position coordinates of the optical element 1 are (x, y, z, θx, θy, θz). On the periphery of the optical element 1, three measurement portions 6 are prepared for position measurement in the optical axis direction, and three measurement portions 6 are prepared for position measurement in the radius vector direction, in portions at an interval of 120° around the optical axis 8 and at the same distance from the optical axis 8. Output signals (converted into relative distances on the individual axes) from the position measurement devices 3 are (S1v, S2v, S3v) in the optical axis direction, and (S1h, S2h, S3h) in the radius vector direction. The displacement (dx, dy, dz, dθx, dθy, dθz) of the optical element 1 is given by, for example, equation (1) below. The obtained displacement is the displacement measured by the position measurement devices 3.

$$\{ \begin{matrix}S 1 h \\ S 2 h \\ S 3 h \\ S 1 v \\ S 2 v \\ S 3 v\end{matrix} \} = [ \begin{matrix}cos ( 50 ° ) & - sin ( 50 ° ) & L 1 & 0 & 0 & 0 \\ cos ( 70 ° ) & sin ( 70 ° ) & L 1 & 0 & 0 & 0 \\ - cos ( 10 ° ) & - sin ( 10 ° ) & L 1 & 0 & 0 & 0 \\ 0 & 0 & 0 & - 1 & L 1 cos ( 50 ° ) & - L 1 sin ( 50 ° ) \\ 0 & 0 & 0 & - 1 & L 1 cos ( 70 ° ) & L 1 sin ( 70 ° ) \\ 0 & 0 & 0 & - 1 & - L1cos ( 10 ° ) & - L 1 sin ( 10 ° )\end{matrix} ] \{ \begin{matrix}dx \\ dy \\ d {θ}_{z} \\ dz \\ d {θ}_{x} \\ d {θ}_{y}\end{matrix} \} \qquad ( 1 )$$

where L1 is the radius to each measurement portion. Note that the displacement of the optical element is the difference (displacement amount) from the origin of the position measurement device 3, specifically, the displacement amount from an “initial position” (to be described later).

The controller 5 includes a wavefront analysis unit 10 that receives wavefront data obtained from the wavefront measurement device 4 and analyzes the wavefront, and a position analysis unit 11 that processes data obtained from the wavefront analysis unit. The wavefront measurement device 4 includes a system that causes a reflected wave in the effective region of the optical element 1 to interfere with a reference wave generated by a reference surface as a measurement reference. The reference wave is ideally a spherical wave or plane wave (a spherical wave is used in this embodiment). Since the optical path length changes by reflecting the surface shape of the effective region, the reflected wave has a wavefront reflecting the surface shape. By observing an interference fringe of the reference wave and reflected wave, a shift (an optical length difference or phase difference) from the reference wavefront can be obtained as the wavefront aberration (wavefront shape) of the effective region. Furthermore, the difference (change) between the positions or shapes of the effective region can be obtained by measuring the wavefronts at two arbitrary times and calculating the difference between the measured wavefronts.

The obtained wavefront aberration indicates a shift in the normal line direction of the reference wavefront (spherical wave). In practice, this wavefront aberration is obtained by processing information obtained by mapping wavefront aberrations in the individual directions in two dimensions (in a plane) and receiving light by an area sensor. Note that a coordinate system thus handling the wavefront aberration will be called a normal line coordinate system hereinafter. The wavefront aberration obtained as the shift of a measurement wavefront from the reference wavefront (spherical wave) in the optical axis direction is also obtained by processing information obtained from two-dimensional mapping. A coordinate system thus handling the wavefront aberration will be called an optical axis coordinate system hereinafter.

The wavefront analysis unit 10 performs analysis by using a Zernike polynomial suited to analysis of the wavefront data obtained from the wavefront measurement device 4, and calculates optically significant Zernike coefficients (the coefficients of terms of the Zernike polynomial). A Zernike polynomial is a complete orthogonal function, and each term corresponds to the optical aberration. A Zernike polynomial is also a series suitable for expansion of an axially symmetrical plane, and the circumferential direction can be expanded into a trigonometric series. That is, when represented by a polar coordinate system (ρ: radius vector, θ: argument), a wavefront W can be expanded into

$$W ( ρ , θ ) = {\sum }_{i} {C}_{i} {f}_{i} ( ρ , θ ) \qquad ( 2 )$$

where Ci is the coefficient of each term, and fi is a radius vector polynomial.

For example, Table 1 below shows the functions of the first to fourth terms of the Zernike polynomial.

TABLE 1

| 1 | Cᵢ | fᵢ |
|---|---|---|
| 1 | C₁ | 1 |
| 2 | C₂ | ρcosθ |
| 3 | C₃ | ρsinθ |
| 4 | C₄ | 2ρ² − 1 |

By using the Zernike polynomial explained above, the wavefront shape obtained by the wavefront measurement device 4 is fitted by the least square method, thereby obtaining the coefficient of each term (this operation will be called Zernike analysis hereinafter). The number of terms of expansion performed in fitting is set in accordance with, e.g., the balance between the load of the calculating process and the truncation error of expansion.

Then, the position analysis unit 11 calculates the position of the optical element 1 from the obtained coefficients. The first to fourth terms of the Zernike coefficients correspond to the position, and higher-order terms practically correspond to deformation. This will be explained first. The second and third terms obviously respectively represent the displacements in the X and Y directions. The displacement in the Z direction is as follows. Assume that only the Z displacement occurs, because the first and fourth terms contain no angular component. In this case, the Z displacement can be represented by only the 0θ term of the Zernike polynomial. However, when approximation is performed by regarding that a high-order component is small, the Z displacement can be represented by, e.g., a composite function including only the first and fourth terms. When deriving the Z displacement in positions where ρ=0 (the center) and ρ=1 (the outermost periphery), dz=C1+C4 when ρ=0. On the other hand, when ρ=1, the displacement in the normal line direction is given by dz=C1+C4. When this equation is approximately projected in the Z direction, the displacement is given by

$$dz \approx \frac{{C}_{1} + {C}_{4}}{cos ϕ} λ = \frac{{C}_{1} + {C}_{4}}{\sqrt{1 - {NA}^{2}}} λ \qquad ( 3 )$$

where λ is the (measurement) light source wavelength, φ is the half-angle of the angular aperture (maximum conical angle), NA is the numerical aperture, and NA=sin φ.

Accordingly, when the Z displacements at two points are compared (by assuming that the values at the two points are almost equal), the Z displacement is given by equation (4) below. Note that the X and Y displacements are also shown.

$$dz \approx \frac{- 2 {C}_{4} λ}{1 - \sqrt{1 - {NA}^{2}}} , \\ dx = \frac{{C}_{2} λ}{NA} , \\ dy = \frac{{C}_{3} λ}{NA} \qquad ( 4 )$$

By using the conversion expressions described in equation (4), the position of the optical element can be approximately calculated by conversion from the Zernike coefficients obtained by Zernike analysis.

As described above, the position measurement device 3 and position analysis unit 9 obtain the position of the optical element 1.

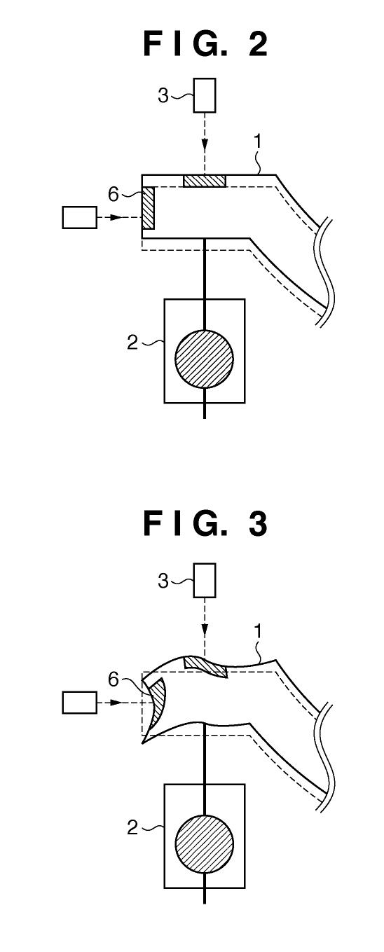

If the measurement portion 6 deforms, the position of the optical element 1 obtained by measurement and analysis (to be also simply referred to as measurement hereinafter) of the measurement portion 6 contains offset. Assume that “offset” herein mentioned is a shift from a position where it is guaranteed that the optical element 1 does not deform when the position of the optical element 1 is displaced. FIGS. 2 and 3 are enlarged schematic views showing the vicinities of the optical element 1, position measurement devices 3, and driving device 2. FIG. 2 shows an ideal state in which the measurement portions 6 do not deform when the optical element 1 is moved by the operation of the driving device 2. By contrast, FIG. 3 shows a state in which the measurement portions 6 deform under the influence of driving. Possible factors causing this deformation (offset) are, for example, the change in stress of a supporting portion resulting from the change in position of the optical element 1, and the influence of the change in stress resulting from the operation (driving process) of the driving device 2. The factors can also include an Abbe error resulting from the relative positional relationship between the measurement portion 6 and position measurement device 3.

Assume that when driving is performed from a certain state, deformation of the measurement portion 6 has produced an offset of 1 nm in the read value S1h of the position measurement device 3. In this case, an error of about 0.5 nm is produced in each of the X and Y shifts (dx,dy) in accordance with equation (1). Also, an error of about 3 nrad is produced in the θZ tilt (dθz).

On the other hand, the wavefront measurement device 4, wavefront analysis unit 10, and position analysis unit 11 can obtain the position of the optical element 1 without being directly influenced by the deformation of the measurement portion 6.

By comparing the positions (displacements) obtained by the above two methods, it is possible to obtain, for example, offset corresponding to the position of the optical element 1 measured by the position measurement device 3. The controller 5 further includes a calibration unit 12 for obtaining this offset.

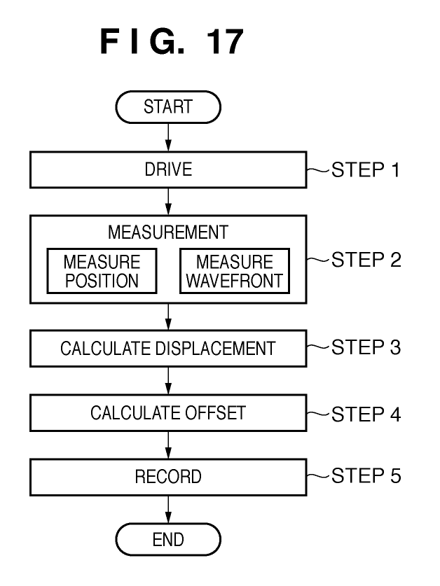

FIG. 17 is a flowchart showing the procedure of processing by which the calibration unit 12 obtains the offset of the position measurement device 3 in the positioning apparatus of this embodiment. First, the driving device 2 drives the drive portion of the optical element 1 by a specific operation (step 1). After that, the position measurement device 3 measures the measurement portion 6 and the wavefront measurement device 4 measures the wavefront aberration in the effective region of the optical element 1 in parallel (step 2). Then, the calibration unit 12 calculates the displacements of the optical element 1 from the measurement results obtained by the measurements in step 2 (step 3). Subsequently, the calibration unit 12 calculates the offset by comparing the displacements obtained from the position measurement device 3 and wavefront measurement device 4 (step 4). After that, the calibration unit 12 records the obtained offset (step 5).

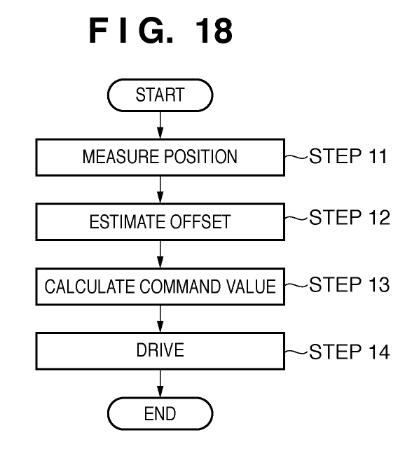

FIG. 18 is a flowchart showing the procedure of the process of positioning the optical element 1 by using the positioning apparatus calibrated as described above. First, the position measurement device 3 measures the present position of the optical element 1 (step 11). Then, based on the obtained present position and a target position, an offset operating unit 17 estimates the offset corresponding to the measurement value from the position measurement device 3 (step 12). Subsequently, the offset operating unit 17 calculates a positioning command value (control command value) based on the estimated offset (step 13). A drive controller 16 operates the driving device 2 based on the calculated command value (step 14).

By the calibration and positioning as described above, the positioning apparatus of this embodiment can accurately calibrate the position measurement device 3 and precisely position the optical element 1.

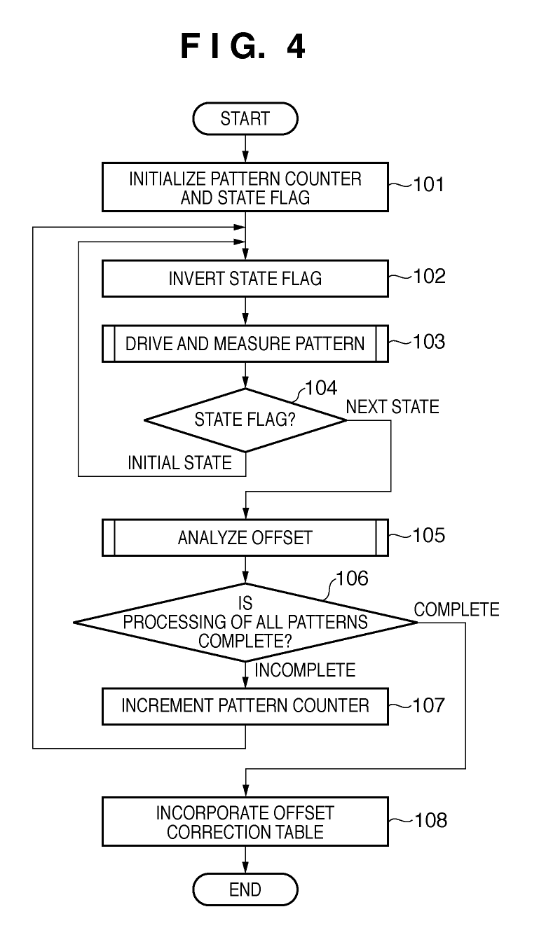

Calibration of the position measurement device 3 and positioning of the optical element 1 explained with reference to FIGS. 17 and 18 will be explained in more detail below. The procedure of calibration will be explained below with reference to FIG. 4. Note that FIG. 4 is an example of a flowchart showing the procedure of the calibration process performed by the calibration unit 12 shown in FIG. 1.

First, when calibration is started, a pattern counter having the function of a loop counter and a state flag are initialized (step 101). The pattern counter is used to designate the conditions (information such as a calibration pattern (to be described later) and a calibration result storage location) of calibration. The state flag is used to determine whether the present state is an initial state or next state under the set conditions. When the operation enters the loop of the sequence, the state flag immediately switches to “initial state” (step 102).

The initial state herein mentioned is a state in which the optical element 1 is in an initial position. The initial position can be a position when the application voltage of the driving device 2 is OFF or set at a predetermined voltage value, or when the output from the position measurement device 3 indicates a prescribed value. The initial position can also be a position when the wavefront measurement device 4 measures the wavefront and the aberration is practically “null”. “Null” indicates a state in which it is possible to regard that there is no aberration. Note that the initial state need not be the initial position, and may also be a state in which the optical element 1 has displaced or deformed by a predetermined amount from the initial position. The next state (to be described later) is a state in which the optical element 1 has further displaced or deformed from the initial state.

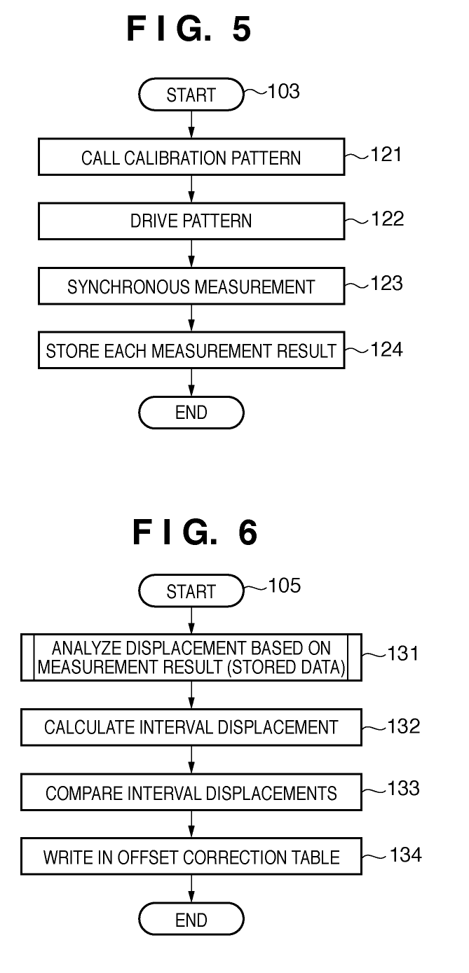

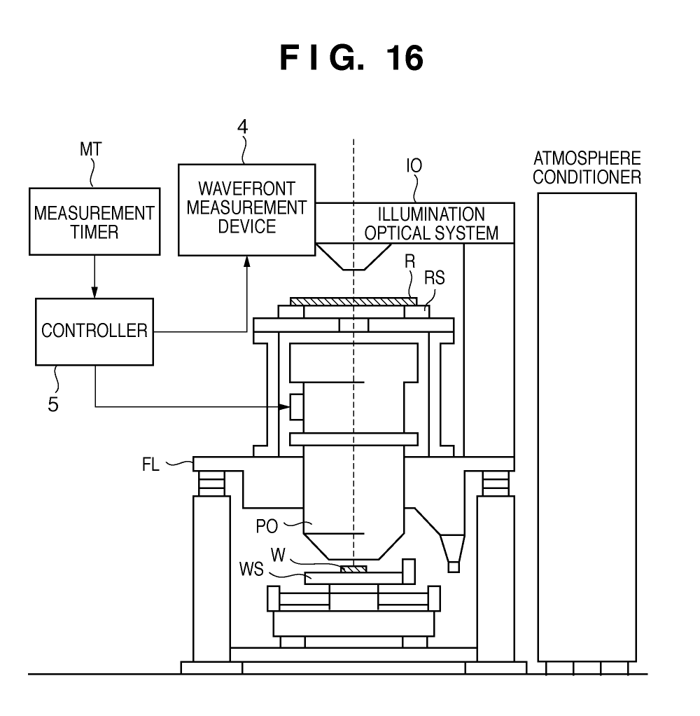

Then, pattern driving and measurement are performed (step 103). FIG. 5 is a flowchart showing the process in step 103. First, a calibration pattern is called (step 121). The calibration pattern can include a driving pattern for calibrating the driving device 2, the initialization conditions of the individual devices, control conditions, and the initialization and generation procedures of an offset correction table. Examples of the initialization conditions of the individual devices are the measurement conditions of the wavefront measurement device 4, and the set conditions of a timer (KT in FIG. 16) for synchronizing measurements performed by the position measurement device 3 and wavefront measurement device 4. The control conditions include the driving conditions of the driving device 2, and can include, e.g., the acceleration limit, and the gain setting of a PID compensator when performing servo control. The calibration driving pattern is registered in, for example, a condition table, and called from the table in accordance with the pattern counter or state flag. In a simple example, the pattern counter is an integer from 1 to the number (Nc) of conditions as an upper limit, the state flag is a binary flag having 0 as the initial state and 1 as the next state, and the product of the pattern counter and state flag is always 0 in the initial state and takes any value from 1 to Nc in the next state. This product can be used as a pointer for calling a condition in the condition table.

Pattern driving is then performed in accordance with the called calibration pattern (step 122). This pattern driving is performed by outputting 0 to all the driving devices 2 in the initial state, and applying an output to each driving device 2 so as to position the optical element 1 in a Z-coordinate of 1 nm in the next state. This driving can be performed by directly applying an output (e.g., a voltage) to the driving device 2, or applying a target position. Also, control of the driving device 2 may be open control or servo control.

Subsequently, the position measurement device 3 and wavefront measurement device 4 perform measurements in parallel (step 123). It is desirable to bring the difference between the measurement states produced by a timing difference close to 0 as much as possible by synchronizing the measurements. After the measurements, the results obtained by the individual measurement devices are temporarily stored (step 124). In this manner, pattern driving and measurements performed by the position measurement device 3 and wavefront measurement device 4 are completed.

Referring to FIG. 4 again, processing after the pattern driving and measurements are completed will be explained below. Whether the state flag is the initial state or next state is determined (step 104). If the state flag is the initial state, the process returns to step 102 of inverting the state flag, and the state flag switches to the next state. The measurement results of the two states are temporarily held through the same processing as in the previous initial state. The process advances to step 105 of analyzing the offset through step 104.

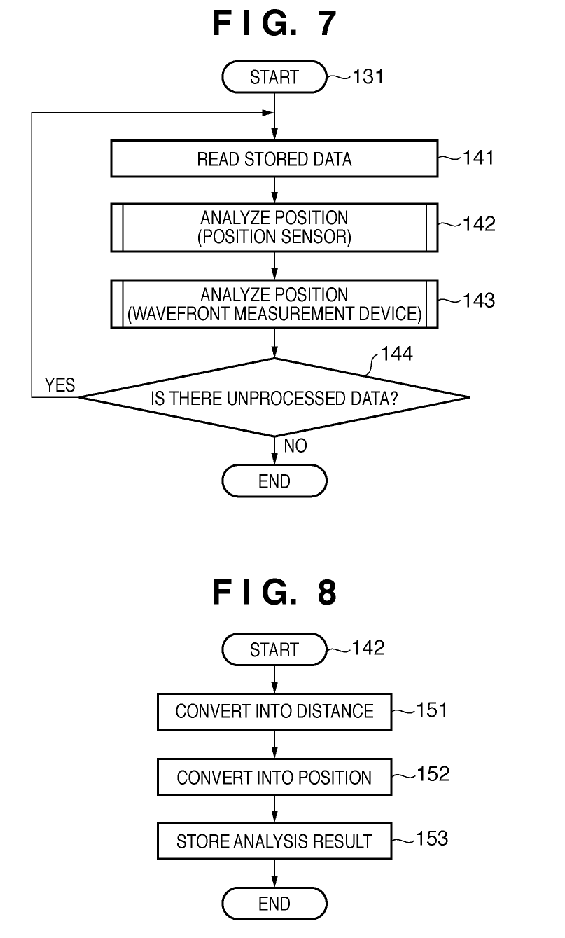

FIG. 6 is a flowchart showing the procedure of the process in step 105 of analyzing the offset. First, the controller 5 analyzes the displacement based on the measurement results (stored data) (step 131). FIG. 7 is a flowchart showing the procedure of the process in step 131. Referring to FIG. 7, the data stored by the pattern driving and measurements are sequentially read (step 141). In this step, it is possible to use a buffer from which the measurement data obtained at the same time by the position measurement device 3 and wavefront measurement device 4 are simultaneously extracted, and the remaining data are aligned at the start position for the next read. Of the pair of read data, the data obtained by the position measurement device 3 undergoes position analysis in step 142, and the data obtained by the wavefront measurement device 4 undergoes position analysis in step 143. Steps 141 to 143 are repeated until there is no more unprocessed data in the temporarily stored data (step 144).

FIG. 8 is a flowchart showing the procedure of the process in step 142 of analyzing the position. In this step, the position analysis unit 9 analyzes the measurement data obtained by the measurement by the position measurement device 3. This data is, for example, a digital counter value in the axial direction of each position measurement device 3. The counter value is converted into the distance from the position measurement device 3 to the measurement portion 6 (step 151). After that, the distance in each axial direction is further converted into the position coordinates (x, y, z, θx, θy, θz) of the optical element 1 (step 152). The coordinates are stored (step 153), and the process is terminated.

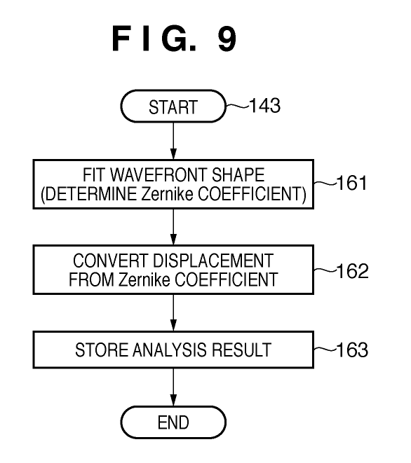

FIG. 9 is a flowchart showing the procedure of the process in step 143 of analyzing the position. In this step, the position analysis unit 11 analyzes the measurement data obtained by the measurement by the wavefront measurement device 4. This data is, for example, planar mapping data of the shift amount (distance) of the mirror surface in the surface normal line direction with respect to the reference spherical wave. The position analysis unit 11 fits this mapping data by using the Zernike polynomial of equation (2), thereby determining Zernike coefficients (step 161). The position analysis unit 11 extracts the second to fourth terms from the determined Zernike coefficients, and substitutes the extracted terms in equation (4), thereby obtaining the position coordinates (to be referred to as wavefront position coordinates hereinafter for the sake of convenience) (dx, dy, dz) based on the reference spherical surface (step 162). The position analysis unit 11 stores the obtained data (step 163), and terminates the process.

When all the position coordinates and wavefront position coordinates of the stored data are obtained by position analysis, the process returns to FIG. 6, and the displacement between the states (an interval displacement) is calculated from the difference between the initial state and next state for each of the position coordinates and wavefront position coordinates (step 132). From the difference between the position coordinates, an interval displacement based on the measurement by the position measurement device 3 is obtained. This displacement is an interval displacement including offset. From the difference between the wavefront position coordinates, an interval displacement based on the measurement by the wavefront measurement device 4 is obtained. This displacement is an interval displacement as the reference of calibration. From the difference between these two interval displacements, the offset of the position measurement device 3 can be extracted (calculated) (step 133). The calculated offset is written in a corresponding portion of the offset correction table so as to be associated with the output from the position measurement device (step 134).

A case in which results as shown in Table 2 below are obtained will be explained as a practical example.

TABLE 2

| Measurement | Initial | Next | Interval | |
|---|---|---|---|---|
| device | state | state | displacement | Offset |
| Position | 0 | 100 | 100 | 10 |
| measurement | | | | |
| device | | | | |
| Wavefront | 0 | 90 | 90 | — |
| measurement | | | | |
| device | | | | |

In this example, reference numeral 10 is obtained as the offset. That is, when information “the present position is 100” is obtained by the position measurement device 3, an offset of 10 is presumably produced. Note that the offset correction table in this case is formed in accordance with the output from the position measurement device 3, so the output from the position measurement device 3 in the initial state must indicate 0. When the offset simply has reproducibility and linearity, (offset)÷(next state of position measurement device) need only be written as data of the corresponding axis in the offset correction table. In this case, the offset correction table is a proportional coefficient table. If the offset has no linearity, it is only necessary to add many driving patterns to the calibration conditions, and map the correspondence of the output from the position measurement device 3 and the offset more strictly.

When the offset analysis is complete, the process returns to FIG. 4 again, and the controller 5 determines whether processing of all patterns is complete (step 106). If the pattern counter has not exceeded the upper limit, the pattern counter is incremented (step 107), and the process returns to step 102 of inverting the state flag again so as to be able to perform calibration by using the next pattern, thereby repeating the processing. If processing of all the calibration patterns is complete, this means that the offset correction table is complete. Therefore, the offset correction table is incorporated into the offset operating unit 17 (step 108), and the calibration is terminated.

Note that an interval displacement operating unit 13, comparison operating unit 14, and offset correction table generating unit 15 shown in FIG. 1 form a part of the calibration unit 12. Note also that the drive controller 16 and offset operating unit 17 form a part of the controller 5. The calibration unit 12 and controller 5 can each or collectively be formed by one or a plurality of processors.

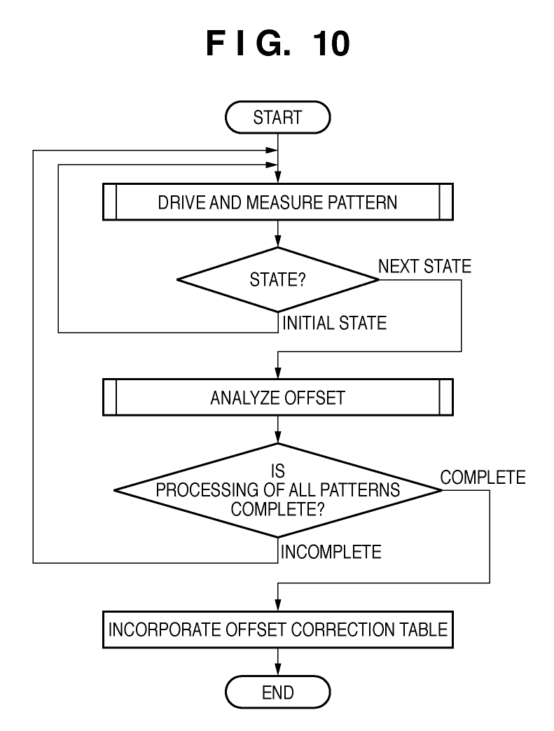

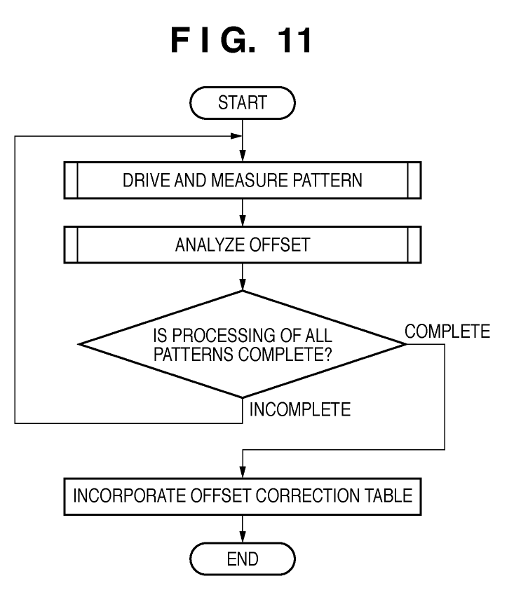

The procedure of the calibration process explained above is an example and does not limit the present invention. For example, FIG. 4 as the main procedure of calibration can simply be described as shown in FIG. 10. In addition, calibration is not necessarily limited to extraction of the offset by comparison of the displacements between the two states. For example, as shown in FIG. 11, it is only necessary to sequentially analyze the offset by a series of calibration patterns, and finally generate an offset correction table. As an example, it is also possible to drive the optical element 1 by every predetermined amount for each axis of the degrees of freedom of driving, and record a coefficient and intercept obtained by linearly approximating the offset corresponding to the axis in the offset correction table.

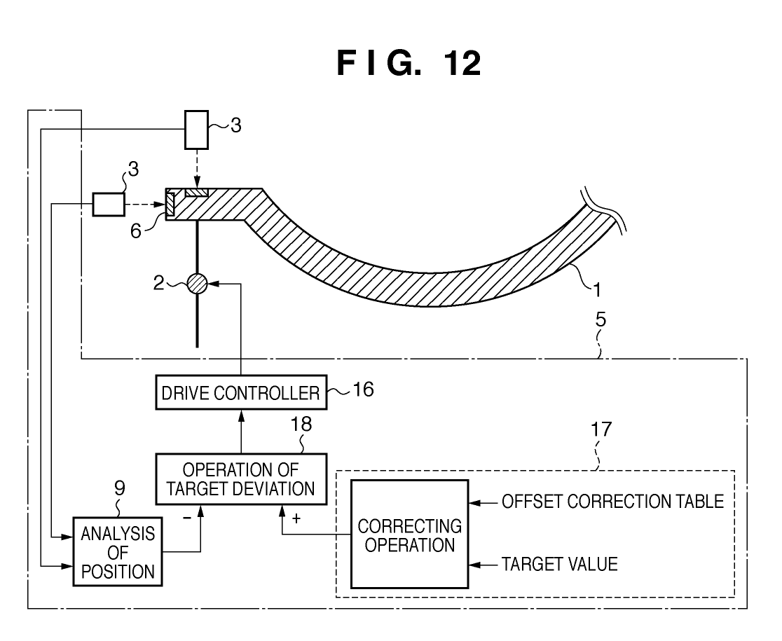

The calibrated positioning apparatus does not require any component for calibration (e.g., the wavefront measurement device 4 and comparison operating unit 14) any longer, and hence can also be manufactured and used as an arrangement as shown in FIG. 12 obtained by removing the calibration unit 12 from FIG. 1. A positioning apparatus having this arrangement can be incorporated into an exposure apparatus and used as a positioning unit of the optical element 1. An exposure apparatus may also include the positioning apparatus having the arrangement as shown in FIG. 1 by incorporating the calibration unit 12 in the structure.

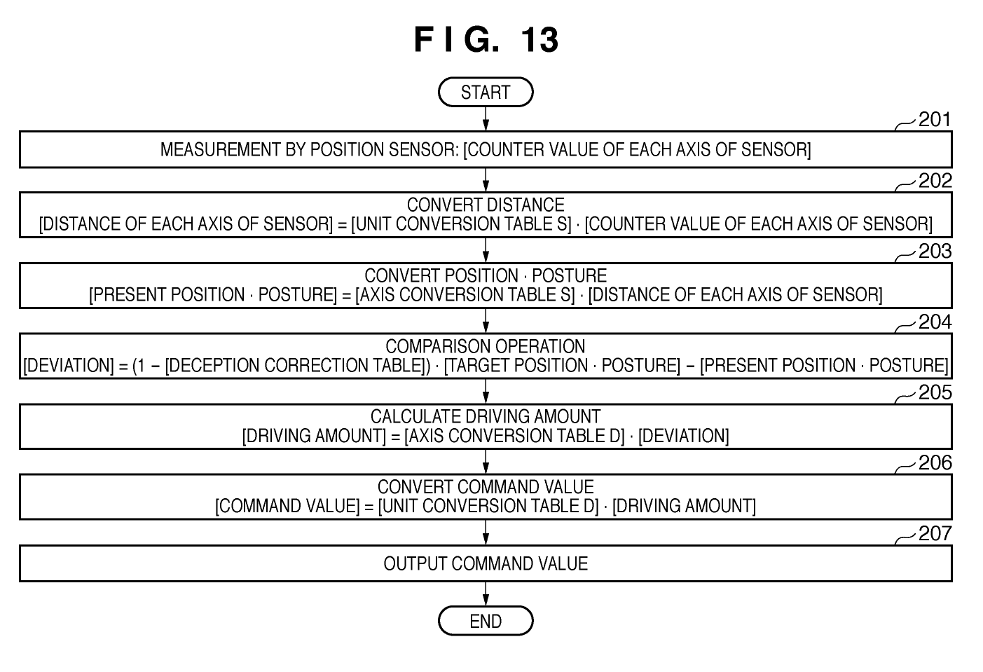

When calibration is complete, the offset operating unit 17 can use the offset correction table, and the optical element 1 can be positioned by the calibrated position measurement device 3. The procedure of the process of positioning the optical element 1 will be explained below with reference to a flowchart shown in FIG. 13. First, the position measurement device (position sensor) 3 measures the present position of the optical element 1 (step 201). The position analysis unit 9 converts the measurement result into the distance in each measurement axial direction (step 202), and further converts the distance into the position coordinates of the optical element 1 (step 203). Subsequently, a target deviation operating unit 18 compares the obtained present position with a target position (corrected target position) corrected by reading out offset in a set target position from the offset correction table, thereby obtaining a deviation (step 204). The target deviation operating unit 18 converts the obtained deviation into a driving amount (step 205), further converts the driving amount into a command value (e.g., a voltage) to the driving device 2 (step 206), and outputs the command value (step 207). Calibrated driving is thus performed. The optical element 1 is positioned by repeating this procedure. In this procedure, correction of the target position by the offset need not be performed every repetition cycle (loop), and may also be performed whenever a target position is generated.

Note that calibration using the offset correction table is performed in accordance with the output from the position measurement device 3, and hence may also be performed for the present position. In this case, it is only necessary to, for example, multiply [present position] by (1−[offset correction table]).

When performing positioning, it is presumably favorable to perform no calibration if the obtained offset is much smaller than or equivalent to various kinds of performance such as the measurement precision of the position measurement device 3, the driving accuracy of the driving device 2, and the stability. If this is the case, it is possible to provide a threshold value for determining whether to apply the offset, and add the process of comparing the threshold value with the offset.

The arrangement of this embodiment explained above can accurately calibrate the position measurement device 3.

### Second Embodiment

In the first embodiment, the Z-axis direction displacement conversion expression represented by equation (4) used in the position analysis unit 11 contains an error produced by approximation. Examples of the error factor are an error on the surface of projection from the normal line direction to the optical axis direction, and a fitting error in Zernike analysis. Although the former error can be decreased by increasing the density of data, the density of an area sensor must be increased. In this case, the amount of data to be processed becomes enormous, and this very increases the load of processing. Therefore, the former error cannot unlimitedly be reduced. For the latter error, a more complete function is obtained by increasing the order of the Zernike polynomial for fitting, and an error of the obtained coefficient also decreases. However, the processing load naturally becomes enormous, and this makes the method impractical. Therefore, the second embodiment taking account of the above-mentioned errors in the first embodiment will be explained below.

In the second embodiment of the present invention, when a wavefront to be processed by a wavefront analysis unit 10 is the wavefront of the normal line coordinate system, this wavefront can be processed by converting the normal line coordinate system into the optical axis coordinate system. Note that the second embodiment further includes a curvature measurement unit for measuring the curvature of an optical element 1, and can obtain a curvature required to convert data of the normal line coordinate system into data of the optical axis coordinate system.

The wavefront analysis unit 10 obtains the Zernike coefficient (to be described as C_{oAn} hereinafter for the sake of convenience) of the wavefront of the optical axis coordinate system by performing Zernike analysis. In this case, a function f_{oA1} of the first term of a Zernike polynomial is represented by

f_{oA1}=1 (5)

Equation (5) represents the change in the Z-axis (optical axis) direction. Accordingly, the coefficient C_{oA1} of the first term of the Zernike polynomial of the optical axis coordinate system represents the position in the Z-axis direction. Note that the positions in the X and Y directions are calculated by the conversion expression represented by equation (4) by processing the wavefront of the normal line coordinate system, as in the first embodiment. That is, a conversion expression used in a position analysis unit 11 is represented by

dz=C_{oA1}λ, dx=C₂λ/NA, dy=C₃λ/NA (6)

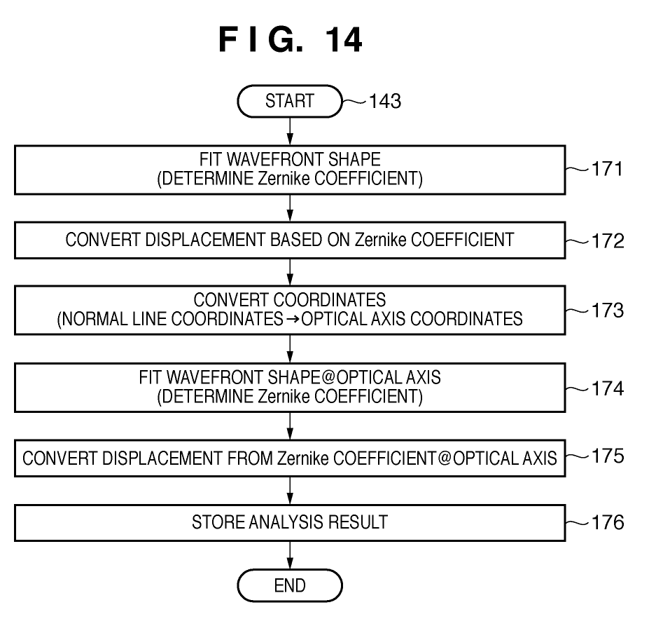

According to equations (6), the position conversion expression in the Z direction practically has no approximation in conversion from the Zernike coefficient, and this eliminates an error in position conversion from the Zernike coefficient. In this embodiment, the flowchart of position analysis shown in FIG. 9 is changed as shown in FIG. 14. First, the wavefront analysis unit 10 obtains Zernike coefficients by performing Zernike analysis on the wavefront data of the normal line coordinate system (step 171). In this case, only the second and third terms are necessary, and the displacements in the X and Y directions are obtained from these terms by using equations (6) (step 172). Then, the wavefront data of the normal line coordinate system is converted into wavefront data of the optical axis coordinate system (step 173). Subsequently, the obtained wavefront data of the optical axis coordinate system undergoes Zernike analysis (step 174). Since a coefficient to be obtained is only the first term, a polynomial to be used in the analysis can be different from that used in step 171. For example, the order of the polynomial can be decreased. The displacement in the Z direction is obtained from the obtained coefficient of the first term by using equations (6) (step 175). In this manner, all the displacements in the X, Y, and Z directions are obtained. The position analysis unit 11 stores these data (step 176), and terminates the processing. The rest of the processing can be the same as that of the first embodiment. Thus, a position measurement device 3 can be calibrated more accurately.

### Third Embodiment

The third embodiment of the present invention is an embodiment in which a wavefront to be processed by a wavefront analysis unit 10 is the wavefront of the optical axis coordinate system. In this case, the wavefront of the normal line coordinate system can be calculated by performing coordinate conversion on the wavefront of the optical axis coordinate system obtained by wavefront measurement. Also, a position analysis unit 11 can use the same conversion expression as equations (6). Thus, a position measurement device 3 can be accurately calibrated in the same manner as in the second embodiment.

### Fourth Embodiment

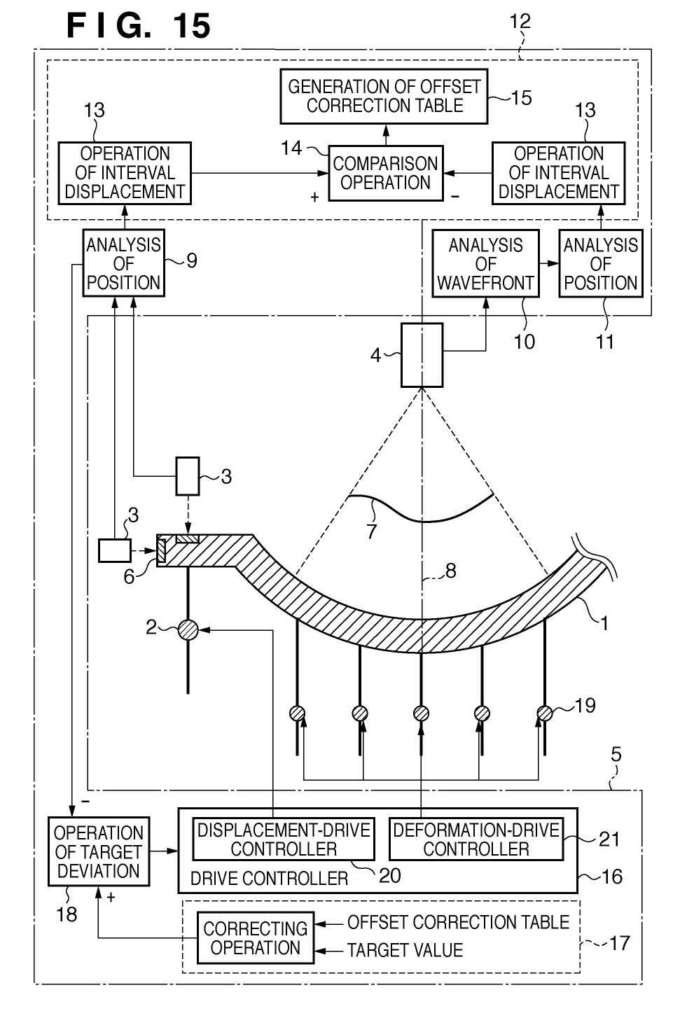

A positioning apparatus of the fourth embodiment of the present invention includes constituent elements for deforming an optical element 1 in addition to the arrangement of the first embodiment. This embodiment will be explained below with reference to FIG. 15. The optical element 1 is a concave mirror, and a plurality of deformation actuators (to be also referred to as deformation-driving units hereinafter) 19 are arranged on the rear surface of the concave mirror. A deformation-drive controller 21 included in a drive controller 16 controls the deformation actuators 19. A wavefront measurement device 4 measures the surface deformation of the optical element 1 caused by this deformation-drive. Also, a displacement-drive controller 20 included in the drive controller 16 controls a driving device (displacement actuator) 2. The same reference numerals as in FIG. 1 denote constituent elements having the same functions as in the first embodiment. This embodiment can obtain predetermined optical characteristics by appropriately changing the surface shape of the optical element 1.

A position measurement device 3 is calibrated even when changing the surface shape. First, while the deformation actuators 19 are not operated, the position measurement device 3 is calibrated by pattern-driving the driving device 2 in the same manner as in the first embodiment. In this case, of Zernike coefficients obtained by wavefront measurement, coefficients except for those used to obtain displacement components are acquired as coefficients of deformation components, and stored as deformation components corresponding to the driving pattern in a separate table (deformation correction table).

Then, under conditions in which the driving device 2 is not operated, displacement produced by driving the deformation actuators 19 is recorded. The deformation actuators 19 are driven in accordance with a predetermined deformation-drive pattern, and wavefront measurement and displacement measurement are performed in this state. Assume that calibration is performed in advance between the wavefront measurement device 4 and deformation actuators 19, so the surface can be changed into a predetermined surface shape by the deformation-drive pattern. The output (displacement amount) from the position measurement device 3 after deformation-drive is recorded as offset corresponding to the deformation-drive pattern. This processing is performed for all predetermined deformation-drive patterns, and offsets are registered in an offset correction table as they are associated with the deformation-drive patterns, thereby completing calibration.

When calibration is thus complete, the obtained table is registered in an offset operating unit 17. For example, when the aberration of the optical element 1 to be corrected is calculated, the deformation-drive controller 21 outputs the corresponding driving amount of the deformation actuators 19. The aberration to be corrected can be obtained from a wavefront aberration obtained by the wavefront measurement device 4, and can also be a wavefront aberration estimated based on the exposure log. Displacement produced by deformation-drive is predetermined or precalculated by using the data in the deformation correction table, and used to correct the output from the position measurement device 3 so as not to change the position measurement value. Thus, the output from the position measurement device 3 is corrected so that the deformation of a measurement portion caused by deformation-drive is not observed as displacement for driving the driving device 2. This makes it possible to accurately position and deform the optical element 1.

When operating the driving device 2 in order to correct the aberration of the optical element 1, the displacement-drive controller 20 outputs the driving amount of the driving device 2. In this case, to cancel (reduce) the deformation amount of the optical element 1 produced by displacement-drive, a deformation amount is precalculated by using the deformation correction table, and the deformation-drive controller 21 outputs a deformation-drive command to the deformation actuator 19 corresponding to the deformation amount. In addition, the output from the position measurement device 3 is corrected in accordance with this deformation-drive command so that the deformation of the measurement portion 6 caused by deformation-drive has no influence on displacement-drive. Thus, the optical element 1 can be accurately positioned and deformed. In this embodiment, the position measurement device 3 can be accurately calibrated even in the positioning apparatus including the deformation-driving unit 19 for deforming the optical element 1.

### Fifth Embodiment

In the fifth embodiment, the present invention is applied to an exposure apparatus for exposing a substrate via an optical element 1. The exposure apparatus has, for example, a projection optical system that projects light from patterns of a master (reticle) onto a substrate (wafer) W. The positioning apparatus explained in any of the first to fourth embodiments described above is applicable to at least one optical element 1 included in the projection optical system.

FIG. 16 is a view showing an example of the arrangement of the exposure apparatus including a projection optical system PO to which the above-mentioned positioning apparatus is applied. In this exposure apparatus, an illumination optical system IO emits illuminating light to a portion of a reticle R placed (held) on a reticle stage RS. The illuminating light is light in the ultraviolet region or vacuum ultraviolet region. The illuminating light forms the shape of a slit on the reticle R so as to illuminate a portion of a pattern region of the reticle R. The projection optical system PO reduces and projects this pattern illuminated in the form of a slit onto the wafer W held on a wafer stage WS. The projection optical system PO is mounted on a frame (support) FL of the exposure apparatus. The reticle R and wafer W are scanned in synchronism with each other relative to the projection optical system PO, thereby transferring the whole pattern region of the reticle R onto a photosensitive agent on the wafer W. This scan exposure is repetitively performed on a plurality of transfer regions (shots) on the wafer W. Note that the exposure apparatus includes the constituent elements of the positioning apparatus described previously. Of these constituent elements, FIG. 16 shows a wavefront measurement device 4 and controller 5. These constituent elements have the same functions as explained in the first to fourth embodiments. Note also that the exposure apparatus includes a measurement timer MT for synchronizing the measurements by a position measurement device 3 and the wavefront measurement device 4.

The projection optical system PO shown in FIG. 16 can be a refracting system, a cata-dioptric system having a reflecting optical element and refracting optical element, or a reflecting system using only a reflecting optical element. When using the cata-dioptric system or reflecting system as the projection optical system PO, the optical characteristics of the projection optical system PO can be adjusted by changing the position of a reflecting optical element (e.g., a concave mirror, convex mirror, or plane mirror) by using the above-mentioned positioning apparatus of the optical element 1. Also, when applying the deformation-driving unit 19 disclosed in the fourth embodiment, the optical characteristics of the projection optical system PO can be adjusted by changing the surface shape of the optical element 1 as well. Note that the optical element 1 to which the present invention is applied is not limited to a reflecting element. An example of calibration of the position measurement device 3 in the positioning apparatus applied to the projection optical system PO as shown in FIG. 16 will be explained below.

Even the position measurement device 3 incorporated into the projection optical system PO can be calibrated in the same manner as disclosed in the first embodiment. To this end, it is necessary to measure the wavefront of a specific optical element 1 as an object to be measured by the position measurement device 3 in the projection optical system PO. To measure the wavefront of the whole projection optical system PO incorporated into the exposure apparatus, it is possible to use known methods such as a method disclosed in Japanese Patent Laid-Open No. 2005-333149 by the present applicant. This measurement will be referred to as “on-body wavefront measurement” hereinafter, and an explanation of a practical method will be omitted.

Information obtained by on-body wavefront measurement is information of the wavefront (to be referred to as “the wavefront of the whole system” hereinafter) obtained over the whole projection optical system. To perform the same processing as disclosed in the first embodiment, information of the wavefront of the specific optical element 1 in the projection optical system PO is necessary. This requires a process (to be also referred to as a projecting process hereinafter) of obtaining the wavefront of the specific optical element 1 from the wavefront of the whole of the projection optical system PO. The specific optical element 1 herein mentioned means an optical element driven by the positioning apparatus, and will be called an optical element to be driven. Assume that when calibrating the position measurement device 3 corresponding to one optical element to be driven, other optical elements belonging to the projection optical system PO are practically at rest.

The procedure of projecting the wavefront of the whole of the projection optical system PO onto the wavefront of an optical element to be driven will be explained below. Let CW be a Zernike coefficient obtained by expanding the wavefront of the whole system into a Zernike polynomial, and CM be a Zernike coefficient obtained from the wavefront of the optical element to be driven. Also, let TWtoM be a table (projection table) for obtaining the Zernike coefficient CM of the optical element to be driven from the Zernike coefficient CW of the whole system. In this case, equation (7) below holds.

C_{M}=T_{WtoM}·C_{W} (7)

The Zernike coefficients CM and CW are, e.g., Zernike coefficient strings obtained by selecting the Zernike coefficients of m terms from those of n terms obtained by expanding the wavefront into a Zernike polynomial including the n terms. Note that m and n are natural numbers, and m≦n. The n terms can be, for example, the first to 36th terms (n=36) of the Zernike polynomial, and can also be a combination of the first to 36th terms and higher-order terms (e.g., n=40) in order to reproduce the 0th term more faithfully. However, variations of the combination of the n terms are not limited to the above examples. Also, m is determined by, for example, selecting 36 Zernike coefficients of the first to 36th terms from 100 Zernike coefficients obtained by expansion into a polynomial including the first to 100th terms.

On the other hands, the projection table TWtoM is formed as follows by embodying equation (7) described above so as to obtain each Zernike coefficient CM of the optical element to be driven by a linear combination of the Zernike coefficients CW of the whole system.

$$[ \begin{matrix}{C}_{M 1} \\ {C}_{M 2} \\ {C}_{M 3} \\ {C}_{M 4}\end{matrix} ] = [ \begin{matrix}{T}_{W 1 M 1} & {T}_{W 2 M 1} & {T}_{W 3 M 1} & {T}_{W 4 M 1} \\ {T}_{W 1 M 2} & {T}_{W 2 M 2} & {T}_{W 3 M 2} & {T}_{W 4 M 2} \\ {T}_{W 1 M 3} & {T}_{W 2 M 3} & {T}_{W 3 M 3} & {T}_{W 4 M 3} \\ {T}_{W 1 M 4} & {T}_{W 2 M 4} & {T}_{W 3 M 4} & {T}_{W 4 M 4}\end{matrix} ] [ \begin{matrix}{C}_{W 1} \\ {C}_{W2} \\ {C}_{W 3} \\ {C}_{W 4}\end{matrix} ] \qquad ( 8 )$$

where the left table on the right side is the projection table containing the coefficients of the linear combination indicating the relationship between CM and CW. Each of CM and CW is represented by the first to fourth terms, and each coefficient CM is a linear combination of each coefficient CW.

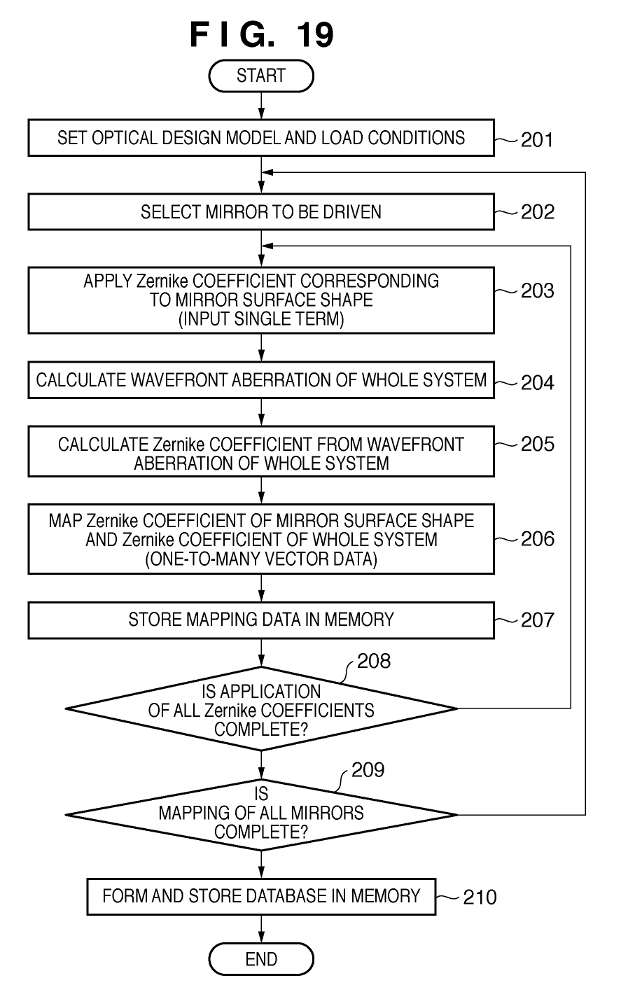

Next, steps of forming the projection table will be explained below. The projection table must be acquired before the position measurement device 3 is calibrated. FIG. 19 is a flowchart showing the procedure of the process of preforming (pregenerating), by simulation using an optical design model, the projection table for obtaining the wavefront of each optical element to be driven from the wavefront of the whole projection optical system. Note that the optical design model has information necessary to calculate the optical characteristics of an optical element in an arbitrary position. This information contains, for example, the material characteristics, surface shape, and position of an optical element, and the characteristics of measurement light. The simulation is performed by a simulator capable of calculating the wavefront by performing analysis by, for example, ray tracing, based on these pieces of information.

Referring to FIG. 19, the settings and conditions of the optical design model are loaded into the simulator (step 201). It is of course also possible to simultaneously load, for example, programs for automatically forming the projection table and the conditions of Zernike analysis. Subsequently, the calculation loop of the projection table is started. First, an optical element to be driven is selected (step 202).

Deformation represented by a Zernike coefficient is applied to the surface shape of the selected optical element to be driven (step 203). The deformation to be applied is most simply the unit amount of an arbitrary term of the Zernike coefficients of finite terms. However, a plurality of terms may also be combined. The simulator calculates the wavefront of the whole system while the deformation represented by the Zernike coefficient is applied (step 204). The simulator then obtains Zernike coefficients by expanding the obtained wavefront into a Zernike polynomial (step 205). In this way, the simulator obtains the relationship between one term of the Zernike coefficients of the optical element to be driven and the Zernike coefficients of the wavefront of the whole system, that is, the linear combination relationship indicated by equation (8) (step 206). The simulator temporarily stores this linear combination relationship (linear combination coefficient) as vector data (step 207). Subsequently, the simulator determines whether there is unapplied deformation corresponding to the Zernike coefficient to be applied to the optical element to be driven (step 208). If there is unapplied deformation, the simulator returns to step 203 to repeat the same processing. If the linear combination relationship has been acquired for every deformation to be applied, the temporarily stored vector data can form a projection table for the present optical element to be driven when combined. In addition, the simulator determines whether the linear combination relationship acquisition process is completely performed for all optical elements as objects of formation of the projection table (step 209). If the linear combination relationship acquisition process is incomplete, the simulator returns to step 202 to select the next optical element to be driven, and repeat the same processing. If the projection table has been acquired for every optical element to be driven, each projection table is registered as a database in a memory unit of the controller 5 (step 210), and the overall processing is terminated.

Since the projection table is acquired, the wavefront of the optical element to be driven can be obtained from the wavefront of the whole system by using the relationship indicated by equation (7). The position measurement device 3 can be calibrated as explained in the first embodiment because the wavefront of the optical element to be driven is obtained.

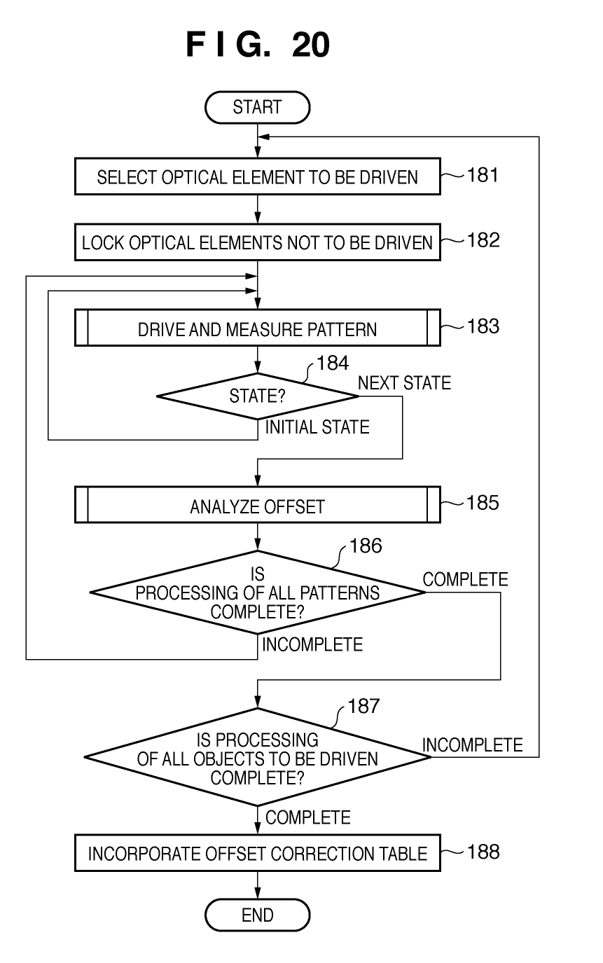

The procedure of the process of calibrating the position measurement device 3 according to this embodiment will now be explained. FIG. 20 is a flowchart showing the procedure of this process. Note that an explanation of those features of calibration of the position measurement device 3 which are explained in the first embodiment will not be repeated.

In this embodiment, calibration concerning an optical element to be driven is performed while other optical elements (optical elements not to be driven) are practically at rest. First, therefore, an optical element to be driven is selected (step 181). In accordance with the selected optical element, conditions such as the preregistered projection table and the driving pattern of the optical element are called. Subsequently, to prevent optical elements not to be driven from operating during the calibration process to exert influence on the results of wavefront measurement, the controller 5 turns off the application voltage of a corresponding driving device 2 or locks the optical elements not to be driven (step 182).

After that, the process advances to a step of driving and measuring a pattern (step 183). In this step, the same processing as shown in FIG. 5 is performed. The controller 5 first calls a calibration pattern defining how to operate the optical element (step 121), and performs pattern driving in accordance with the called pattern (step 122). In the first pattern driving, the optical element is normally driven to an initial position as an initial state. The initial state can be a state in which the application voltage of the driving element is OFF or set at a predetermined voltage value, or a state in which a predetermined positional relationship is held with respect to a global position reference. The initial state can also be a state in which the wavefront aberration of the projection optical system is null (a state in which it is possible to regard that the projection optical system has no aberration). The global position reference can be a sensor for sensing the position of an optical element from outside the positioning apparatus. For example, the global position reference can be a position sensor attached to the barrel of the projection optical system. Note that the initial state need not be the above-mentioned initial position, and may also be a state in which the optical element has displaced or deformed by a predetermined amount from the initial position. The next state (to be described later) is a state in which the optical element has displaced or deformed by a predetermined amount from the initial state.

When pattern driving is complete and the optical element has practically become stationary, synchronous measurement is performed (step 123). Synchronous measurement of this embodiment differs from that of the first embodiment in that wavefront measurement is performed over the whole projection optical system to obtain the wavefront of the whole system. In this step, control is performed so that the position measurement device 3 and wavefront measurement device 4 perform measurements in synchronism with each other. The measurement devices 3 and 4 can each perform measurement once or a plurality of number of times. In addition, data obtained by performing measurement a plurality of number of times can be individually acquired and used, and can also be averaged or added. Also, one or a plurality of image data for wavefront measurement can be subjected to image processing such as noise removal. Subsequently, the measurement data obtained from the position measurement device 3 and wavefront measurement device 4 are stored (step 124). After that, the process returns to step 183 shown in FIG. 20 to determine whether pattern driving and measurement currently being performed are performed on the initial state or next state (step 184). If pattern driving and measurement of the initial state are complete, the same processing is repetitively performed on the next state, and the process returns to step 183.

When pattern driving and measurement on the next state are complete, the process advances to an offset analysis step (step 185). The procedure of processing to be executed by the controller 5 is as shown in FIG. 6. Referring to FIG. 6, the interval displacement of the optical element is analyzed from the stored measurement data (step 131). The procedure of the process in step 131 is as shown in FIG. 7. First, the stored data is read (step 141). The stored data contains two kinds of data. One is the measurement data of the position measurement device. The position of the optical element measured by the position measurement device 3 is obtained by processing this data (step 142). Details of this step are explained in the first embodiment, so a repetitive explanation will be omitted. The other stored data is the measurement data of the wavefront measurement device 4. The position of the optical element measured by the wavefront measurement device 4 is obtained by processing this data (step 143).

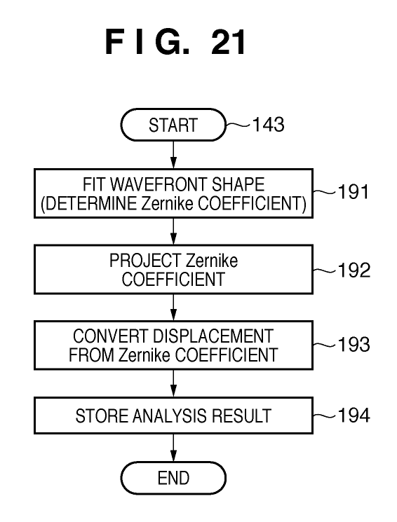

FIG. 21 is a flowchart showing the procedure of the process in step 143. A Zernike coefficient is determined by fitting the shape of the wavefront of the whole system obtained as the measurement data of the wavefront measurement device 4 by using a Zernike polynomial (step 191). Then, a Zernike coefficient projecting process of obtaining the Zernike coefficient of the wavefront of the optical element to be driven from the obtained Zernike coefficient of the wavefront of the whole system is performed (step 192). In this Zernike coefficient projecting process, a projection table corresponding to the optical element to be driven is selected from a preacquired projection table database, and the Zernike coefficient of the wavefront of the optical element to be driven is obtained in accordance with the relation of equation (7).

By using the Zernike coefficient obtained by projection, the position of the optical element to be driven is obtained by the relation of equation (4) (step 193). The obtained position is stored (step 194), and the process advances to step 144 shown in FIG. 7. If unanalyzed data exists in the stored measurement data, the process returns to step 141, and the same processing is repeated. When all the measurement data are completely analyzed, the process returns to the procedure shown in FIG. 6.

When the analysis of the measurement results is complete, the same processing as that of the first embodiment is performed after that. The interval displacement is calculated (step 132), and the interval displacements based on the position measurement device 3 and wavefront measurement device 4 are compared (step 133). The offset of the measurement value of the position measurement device 3, which is obtained in this step based on the measurement value of the wavefront measurement device 4, is written in a predetermined portion of the offset correction table (i.e., in a page of the table managed by, for example, the number of the optical element to be driven, or the driving pattern number) (step 134).

Referring to FIG. 20 again, whether pattern driving and measurement and offset analysis have completely been performed on all the patterns is determined (step 186). If these processes are complete, whether all the optical elements to be driven have completely been processed is determined (step 187). If all the processes have completely been performed on all the optical elements to be driven, the completed offset correction table is incorporated into the controller, and the overall calibration process is terminated.

When performing the above-mentioned processing in the exposure apparatus, it is possible to accurately calibrate the position measurement device 3 for measuring the position of the measurement portion 6 of an optical element to be driven in the projection optical system. The procedure of the process of positioning the optical element by using the positioning apparatus after the calibration is the same as that disclosed in the first embodiment. When using the positioning apparatus calibrated in accordance with this embodiment, an optical element to be driven can be precisely positioned without any frequent wavefront measurement unlike in conventional methods. In addition, although the deformation of an optical element caused by the heat of exposure light can deteriorate the optical characteristics of a projection optical system, this embodiment can reduce the deterioration of the optical characteristics.

Data are collected by simulation or experiments, and the relationship between the exposure log (e.g., the exposure time, exposure energy distribution, and irradiation range) and at least one of the deformation amount of an optical element and the compensation amount of deformation is obtained in advance. Assuming that the difference between the shapes before and after the deformation of an optical element is the deformation amount of the optical element, a deformation amount that cancels this shape difference can be the compensation amount of deformation. In addition, since the driving device (actuator) 2 of the positioning apparatus is used to cancel this deformation, the compensation amount of deformation must be calculated to be achievable by the driving device 2. The exposure apparatus including the positioning apparatus thus controls the driving device 2 based on the exposure conditions and the relationship between the exposure log and the deformation of an optical element. Consequently, at least one of the position and shape of the optical element is controlled so as to cancel the deformation of the optical element caused by the heat of exposure light. Accordingly, deterioration of the optical characteristics of the projection optical system can be reduced.

[Embodiment of Device Manufacturing Method]

A method of manufacturing a device (e.g., a semiconductor device or liquid crystal display device) of an embodiment of the present invention will be explained below. In this method, the exposure apparatus to which the present invention is applied can be used. The semiconductor device is manufactured through a pre-step of forming an integrated circuit on a wafer (semiconductor substrate), and a post-step of completing the integrated circuit chip formed on the wafer in the pre-step as a product. The pre-step can include a step of exposing a wafer coated with a photosensitive agent by using the above-mentioned exposure apparatus, and a step of developing the wafer exposed in the former step. The post-step can include an assembling step (dicing and bonding) and packaging step (encapsulation). The liquid crystal display device is manufactured through a step of forming a transparent electrode. The step of forming a transparent electrode can include a step of coating a glass substrate having a vapor-deposited transparent conductive film with a photosensitive agent, a step of exposing the glass substrate coated with the photosensitive agent, and a step of developing the glass substrate exposed in the preceding step.

Although the embodiments of the present invention have been explained above, the present invention is not limited to these embodiments, and various modifications and changes can be made within the spirit and scope of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-153397, filed Jun. 11, 2008 and No. 2009-101375, filed Apr. 17, 2009 which are hereby incorporated by reference herein in their entirety.

What is claimed is:

1. A positioning apparatus which comprises a position measuring device configured to measure a position of a measurement portion of an optical element, a driving device configured to displace a drive portion of the optical element, and a controller configured to control the driving device, and positions the measurement portion of the optical element, wherein
the controller is configured to
displace the drive portion of the optical element by a specific operation of the driving device, and calculate a displacement of the optical element as a first displacement based on an output from the position measuring device,
calculate a displacement of the optical element caused by the specific operation as a second displacement, based on an output from a wavefront measuring device configured to measure a wavefront of light directed by the optical element,
based on a difference between the first displacement and the second displacement, calibrate a position of the optical element calculated from the output from the position measuring device, and store a result of the calibration, and
control the driving device based on the stored calibration result and an output from the position measuring device.

2. An apparatus according to claim 1, wherein
the wavefront measuring device is configured to expand a shift amount between the wavefront and a reference wavefront into a Zernike polynomial, and
the controller is configured to obtain the second displacement based on a coefficient of at least one of a first term, a second term, a third term and a fourth term obtained by the expansion into the Zernike polynomial.

3. An apparatus according to claim 2, wherein
the wavefront measuring device is configured to expand a shift amount between the wavefront and the reference wavefront in a direction of a normal line of the reference wavefront into a Zernike polynomial, and
the controller is configured to obtain the second displacement based on a coefficient of at least one of a second term, a third term and a fourth term obtained by the expansion into the Zernike polynomial.

4. An apparatus according to claim 2, wherein
the wavefront measuring device is configured to expand a shift amount between the wavefront and the reference wavefront in a direction of an optical axis of the optical element into a Zernike polynomial, and
the controller is configured to obtain the second displacement based on a coefficient of a first term obtained by the expansion into the Zernike polynomial.

5. An apparatus according to claim 1, wherein the apparatus is configured to adjust at least one of a position and shape of the optical element.

6. An apparatus according to claim 1, further comprising the wavefront measuring device,
wherein the wavefront measuring device is configured to expand a shift amount between a wavefront of light directed via an optical system including the optical element and a reference wavefront into a Zernike polynomial, and
the controller is configured to obtain the second displacement based on a coefficient of a term obtained by the expansion into the Zernike polynomial.

7. An apparatus according to claim 6, wherein the controller is configured to calculate a coefficient of at least one of a first term, a second term, a third term and a fourth term of a Zernike polynomial with respect to the optical element by a linear combination of coefficients of a plurality of terms obtained by the expansion into the Zernike polynomial, and obtain the second displacement based on the calculated coefficient.

8. An apparatus according to claim 1, wherein the controller is configured to cause the driving device to displace the drive portion of the optical element in accordance with each of a plurality of driving patterns, perform the calibration with respect to each of the plurality of driving patterns, obtain a shift amount of a position of the optical element calculated from the output from the position measuring device, based on a result of the calibration performed with respect to each of the plurality of driving patterns and a control command value for the driving device, and control the driving device based on the obtained shift amount and the output from the position measuring device.

9. An exposure apparatus which comprises an optical element and exposes a substrate to light via the optical element, the exposure apparatus comprising a positioning apparatus which positions a measurement portion of the optical element,
wherein the positioning apparatus includes a position measuring device configured to measure a position of the measurement portion of the optical element, a driving device configured to displace a drive portion of the optical element, and a controller configured to control the driving device, and
the controller is configured to
displace the drive portion of the optical element by a specific operation of the driving device, and calculate a displacement of the optical element as a first displacement based on an output from the position measuring device,
calculate a displacement of the optical element caused by the specific operation as a second displacement, based on an output from a wavefront measuring device configured to measure a wavefront of light directed by the optical element,
based on a difference between the first displacement and the second displacement, calibrate a position of the optical element calculated from the output from the position measuring device, and store a result of the calibration, and
control the driving device based on the stored calibration result and an output from the position measuring device.

10. A method of manufacturing a device, the method comprising:
exposing a substrate to light using an exposure apparatus;
developing the exposed substrate; and
processing the developed substrate to manufacture the device,
wherein the exposure apparatus includes an optical element and exposes a substrate to light via an optical element, the exposure apparatus including a positioning apparatus which positions a measurement portion of the optical element,
the positioning apparatus includes a position measuring device configured to measure a position of the measurement portion of the optical element, a driving device configured to displace a drive portion of the optical element, and a controller configured to control the driving device, and
the controller is configured to
displace the drive portion of the optical element by a specific operation of the driving device, and calculate a displacement of the optical element as a first displacement based on an output from the position measuring device,
calculate a displacement of the optical element caused by the specific operation as a second displacement, based on an output from a wavefront measuring device configured to measure a wavefront of light directed by the optical element,
based on a difference between the first displacement and the second displacement, calibrate a position of the optical element calculated from the output from the position measuring device, and store a result of the calibration, and
control the driving device based on the stored calibration result and an output from the position measuring device.

11. A method of manufacturing a positioning apparatus which includes a position measuring device for measuring a position of a measurement portion of an optical element, a driving device for displacing a drive portion of the optical element, and a controller for controlling the driving device, and positions the measurement portion of the optical element, the method comprising:
assembling the optical element, the position measuring device, and the driving device into a predetermined positional relationship;
displacing the drive portion of the optical element by a specific operation of the driving device, and calculating a displacement of the optical element as a first displacement based on an output from the position measuring device;
calculating a displacement of the optical element caused by the specific operation as a second displacement, based on an output from a wavefront measuring device for measuring a wavefront of light directed by the optical element;
based on a difference between the first displacement and the second displacement, calibrating a position of the optical element calculated from the output from the position measuring device; and
causing the controller to store a result of the calibration.

12. A method of manufacturing an exposure apparatus which exposes a substrate to light via an optical system supported by a supporting member, the method comprising:
assembling the optical system by arranging an optical element, a positioning apparatus for positioning a measurement portion of the optical element, and another optical element different from the former optical element; and
attaching the assembled optical system to the supporting member,
wherein the positioning apparatus is manufactured by a method including:
assembling the optical element, a position measuring device for measuring a position of a measurement portion of the optical element, and a driving device for displacing a drive portion of the optical element into a predetermined positional relationship;
displacing the drive portion of the optical element by a specific operation of the driving device, and calculating a displacement of the optical element as a first displacement based on an output from the position measuring device;
calculating a displacement of the optical element caused by the specific operation as a second displacement, based on an output from a wavefront measuring device for measuring a wavefront of light directed by the optical element;
based on a difference between the first displacement and the second displacement, calibrating a position of the optical element calculated from the output from the position measuring device; and
causing a controller for controlling the driving device to store a result of the calibration.

13. A positioning method to be executed in a positioning apparatus which includes a position measuring device for measuring a position of a measurement portion of an optical element, a driving device for displacing a drive portion of the optical element, and the controller for controlling the driving device, and positions the measurement portion of the optical element, the method comprising:
displacing the drive portion of the optical element by a specific operation of the driving device, and calculating a displacement of the optical element as a first displacement based on an output from the position measuring device;
calculating a displacement of the optical element caused by the specific operation as a second displacement, based on an output from a wavefront measuring device for measuring a wavefront of light directed by the optical element;
based on a difference between the first displacement and the second displacement, calibrating a position of the optical element calculated from the output from the position measuring device, and storing a result of the calibration; and
controlling the driving device based on the stored calibration result and an output from the position measuring device.
